(19) United States
(12) Patent Application Publication
(10) Pub. No.: US 2015/0109177 A1
(43) Pub. Date: Apr. 23, 2015

(54) MULTI-BAND ANTENNA

(71) Applicant: THE BOEING COMPANY, Chicago, IL (US)

(72) Inventor: Ronald O. Lavin, Gilbert, AZ (US)

(73) Assignee: THE BOEING COMPANY, Chicago, IL (US)

(21) Appl. No.: 14/058,521

(22) Filed: Oct. 21, 2013

(51) Int. Cl. H01Q 5/01; H01Q 13/10; H01Q 9/06

(52) U.S. Cl. CPC H01Q 5/01; H01Q 9/06; H01Q 13/10
USPC 343/770; 343/793

(57) ABSTRACT

A compact multi-band antenna structure consisting of overlapping elements formed like tree rings is described. A dipole multi-band antenna includes a first arm having a first conductive cylinder with a predetermined length corresponding to a first frequency and a second conductive cylinder having a predetermined length corresponding to a second frequency positioned over the first conductive cylinder without contact between the first conductive cylinder and the second conductive cylinder. A first end of the first conductive cylinder is in the same plane as and is electrically coupled to a first end of the second conductive cylinder. A second arm is similarly formed. A feed line is coupled to the first and second conductive cylinders and to the cylinders in the second arm. Additional frequencies may be added by similarly stacking additional conductive cylinders. The structure is also applied to monopole, circular, spiral, helical and slot antennas.

### FIELD OF THE DISCLOSURE

This invention relates generally to a multi-band antenna structure and methods for forming multi-band antenna structures.

### BACKGROUND

A dipole antenna is a resonant antenna which consists of two identical bilaterally symmetrical conductive elements coupled to a feed line. Signals are applied to (for a transmitter) or taken from (for a receiver) between the two elements of the antenna via the feed line. A common form of dipole is two straight rods or wires oriented end to end on the same axis, with the feed line connected to the two adjacent ends. Since a dipole antenna is a resonant antenna, the length of the conductive elements are related to the wavelength of the radio waves to be transmitted or received. Similarly, a monopole antenna is also a resonant antenna which consists of a single conductive element coupled to one side of the feed line, with the other side of the feed line connected to a ground connection. A feed line is transmission line that has a specific characteristic impedance and which must be designed to match the characteristics of particular antenna and transmitter in use in order to transfer power efficiently to the antenna.

A slot antenna consists of a metal surface, e.g., a flat plate, having a hole (slot) formed in a middle portion thereof. When the metal surface is driven at a predetermined frequency across the slot (set by the shape and size of the slot), the slot radiates electromagnetic waves in a manner similar to a dipole antenna.

Most antennas, e.g., monopole, dipole and slot, are designed to transmit (or receive) a particular single frequency range. Thus, in order to transmit signals having different frequency ranges (e.g., in a multi-band radio), separate antennas are needed for each of the different frequency ranges, each requiring associated separate feed lines. This requires added space and expense.

### SUMMARY

The present invention addresses the problems of the prior art by providing a more compact structure. The compact structure includes overlapping elements that are similar to the growth rings on a tree, also called tree rings. In one embodiment, a multi-band antenna has a first conductive element, a second conductive element and a first conductive member. The first conductive element has a central axis, a predetermined cross-sectional shape, and a predetermined first length. The second conductive element is hollow and has a central axis, a predetermined cross-sectional shape, and a predetermined second length which is less than the predetermined length of the first conductive element. The predetermined cross-sectional shape of the second conductive element is sized to allow the second conductive element to fit over the first conductive element without contact between the first conductive element and the second conductive element. The second conductive element is aligned over the first conductive element such that the central axis of the first conductive element coincides with the central axis of the second conductive element and such that a first end of the first conductive element is in the same plane as a first end of the second conductive element. The first conductive member is coupled to the first end of the first conductive element and to the first end of the second conductive element such that electrical connection to both elements is possible. A spacing of air or dielectric material between the first conductive element and the second conductive element ensures these elements are not in direct contact except at the first end where the first conductive member contacts both elements. Preferably, the predetermined cross-sectional shape of the first conductive element of the first conductive element is the same as the predetermined cross-sectional shape of the second conductive element. In a preferred embodiment, the predetermined cross-sectional shape may be a circle. In other embodiments, the predetermined cross-sectional shape may be a square, triangular, oval, or other shape. Preferably, the first conductive element and the second conductive element form straight rods. In other embodiments, the first conductive element and the second conductive element form looped rods, spiral rods, or other shapes. A feed line is coupled to the first conductive member such that the first and second conductive elements coupled to the feed line through the conductive member are fed in phase.

In a further embodiment, the multi-band antenna further includes a third conductive element that is hollow and has a central axis, a predetermined cross-sectional shape and a predetermined third length. The predetermined cross-sectional shape of the third conductive element is sized to allow the third conductive element to fit over the second conductive element without contact between the second conductive element and the third conductive element. The third conductive element is aligned over the second conductive element such that the central axis of the second conductive element coincides with the central axis of the third conductive element and such that a first end of the second conductive element is in the same plane as a first end of the third conductive element. In this further embodiment, the first conductive member is coupled to the first end of the first, second, and third conductive elements. In the further embodiment, the predetermined length of the third conductive element is less than the predetermined length of the second conductive element. A feed line is coupled to the first conductive member such that the first, second and third conductive elements coupled to the feed line through the conductive member are fed in phase.

In a still further embodiment, the multi-band antenna further includes a third conductive element, a fourth conductive element and a second conductive member. The third conductive element has a central axis, a predetermined cross-sectional shape the same as the predetermined cross-sectional shape of the first conductive element, and a predetermined third length. The third conductive element is aligned adjacent to the first conductive element so that the central axis of the first conductive element is in line with the central axis of the third conductive element and so that the first end of the first conductive element is adjacent to but spaced apart from a first end of the third conductive element. The fourth conductive element is hollow and has a central axis, a predetermined cross-sectional shape the same as the predetermined cross-sectional shape of the second conductive element and a predetermined fourth length. The predetermined cross-sectional shape of the fourth conductive element is sized to allow the fourth conductive element to fit over the third conductive element without contact between the third conductive element and the fourth conductive element. The fourth conductive element is aligned over the third conductive element such that the central axis of the third conductive element coincides with the central axis of the fourth conductive element and such that the first end of the third conductive element is in the same plane as a first end of the fourth conductive element. The second conductive member is coupled to the first end of the third conductive element and to the first end of the fourth conductive element. In the still further embodiment, the predetermined second length is preferably less than the predetermined first length and the predetermined fourth length is preferably less than the predetermined third length. A first feed line is coupled to the first conductive member such that the first and second conductive elements coupled to the first feed line through the first conductive member are fed in phase. A second feed line is coupled to the second conductive member such that the third and fourth elements coupled to the second feed line through the second conductive member are fed in phase.

In another further embodiment, the multi-band antenna also includes a fourth conductive element, a fifth conductive element, a sixth conductive element and a second conductive member. The fourth conductive element has a central axis, a predetermined cross-sectional shape the same as the predetermined cross-sectional shape of the first conductive element, and a predetermined fourth length. The fourth conductive element is aligned adjacent to the first conductive element so that the central axis of the first conductive element is in line with the central axis of the fourth conductive element and so that the first end of the first conductive element is adjacent to but spaced apart from a first end of the fourth conductive element. The fifth conductive element is hollow and has a central axis, a predetermined cross-sectional shape the same as the predetermined cross-sectional shape of the second conductive element and a predetermined fifth length. The predetermined cross-sectional shape of the fifth conductive element is sized to allow the fifth conductive element to fit over the fourth conductive element without contact between the fourth conductive element and the fifth conductive element. The fifth conductive element is aligned over the fourth conductive element such that the central axis of the fourth conductive element coincides with the central axis of the fifth conductive element and such that the first end of the fourth conductive element is in the same plane as a first end of the fifth conductive element. The sixth conductive element is hollow and has a central axis, a predetermined cross-sectional shape and a predetermined sixth length. The predetermined cross-sectional shape of the sixth conductive element is sized to allow the sixth conductive element to fit over the fifth conductive element without contact between the fifth conductive element and the sixth conductive element. The sixth conductive element is aligned over the fifth conductive element such that the central axis of the fifth conductive element coincides with the central axis of the sixth conductive element and such that a first end of the fifth conductive element is in the same plane as a first end of the sixth conductive element. The second conductive member is coupled to the first end of the fourth conductive element, to the first end of the fifth conductive element, and to the first end of the sixth conductive element. A first feed line is coupled to the first conductive member such that the first, second and third conductive elements coupled to the first feed line through the first conductive member are fed in phase. A second feed line is coupled to the second conductive member such that fourth, fifth and sixth conductive elements coupled to the second feed line through the second conductive member are fed in phase.

In another embodiment, the multi-band antenna includes a first helical element, a second helical element and a first conductive member. The first helical element has a central axis, a predetermined cross-sectional outer diameter, and a predetermined first length. The second helical element has a central axis, a predetermined cross-sectional inner diameter and a predetermined second length. The predetermined cross-sectional inner diameter of the second helical element is greater than the predetermined cross-sectional outer diameter of the first helical element so that the second helical element fits over the first helical element without contact between the first helical element and the second helical element. The second helical element is aligned over the first helical element such that the central axis of the first helical element coincides with the central axis of the second helical element and such that a first end of the first helical element is in the same plane as a first end of the second helical element. The first conductive member is coupled to the first end of the first helical element and to the first end of the second helical element. A single feed line having a first conductor is coupled to the first conductive member such that the first and second helical elements coupled to the first conductive member are fed in phase.

In another embodiment, the multi-band antenna includes a first slot antenna, a second slot antenna, a first conductive member and a second conductive member. The first slot antenna is formed from a first metal plate. The first metal plate has an aperture formed therein. The aperture has a predetermined first size corresponding to a particular first resonant frequency. The first slot antenna has a first tine and a second tine. The first tine has a first end and a second end. The first end of the first tine is electrically coupled to the second metal plate at a first side of the aperture and the second end of the first tine is positioned in a middle portion of the aperture. The second tine has a first end and a second end. The first end of the second tine is electrically coupled to the second metal plate at a second side of the aperture opposite the first side and the second end of the second tine is positioned in the middle portion of the aperture. The second end of the first tine is separate from and not electrically coupled to the second end of the second tine. The second slot antenna is formed from a second metal plate. The second metal plate has an aperture formed therein. The aperture has a predetermined second size corresponding to a particular second resonant frequency. The second slot antenna has a first tine and a second tine. The first tine has a first end and a second end. The first end of the first tine is electrically coupled to the second metal plate at a first side of the aperture and the second end of the first tine is positioned in a middle portion of the aperture. The second tine has a first end and a second end. The first end of the second tine is electrically coupled to the second metal plate at a second side of the aperture opposite the first side and the second end of the second tine is positioned in the middle portion of the aperture. The second end of the first tine is separate from and not electrically coupled to the second end of the second tine. The first slot antenna is positioned over but spaced apart from the second slot antenna such that the second end of the first tine of the first slot antenna is adjacent to the second end of the first tine of the second slot antenna and the second end of the second tine of the first slot antenna is adjacent to the second end of the second tine of the second slot antenna. The first conductive member is coupled to the second end of the first tine of the first slot antenna and to the second end of the first tine of the second slot antenna. The second conductive member is coupled to the second end of the second tine of the first slot antenna and to the second tine of the second slot antenna. A feed line is coupled to the first and second conductive members such that first and second slot elements coupled to the first feed line through the conductive members are fed in phase.

### BRIEF DESCRIPTION OF THE DRAWINGS

The following detailed description, given by way of example and not intended to limit the present invention solely thereto, will best be understood in conjunction with the accompanying drawings in which:

FIG. 1 is a perspective diagram of an embodiment of a multi-band dipole antenna;

FIG. 2 is a diagram of a center portion of the embodiment of FIG. 1;

FIG. 3 is a chart showing the resonant frequencies of the embodiment of FIG. 1;

FIG. 4 is a schematic diagram showing the equivalent circuit of the embodiment of FIG. 1; and

FIGS. 5A, 5B, 5C, 5D and 5E are perspective diagrams showing alternative embodiments of a multi-band antenna.

### DETAILED DESCRIPTION

In the present disclosure, like reference numbers refer to like elements throughout the drawings, which illustrate various exemplary embodiments.

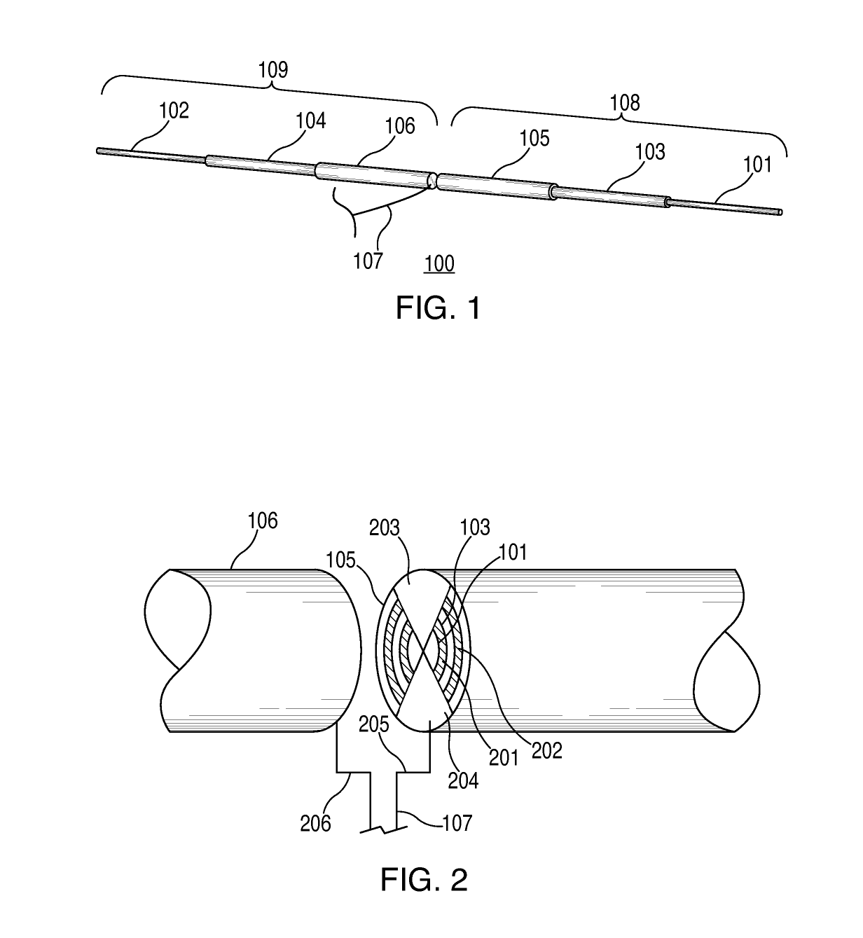

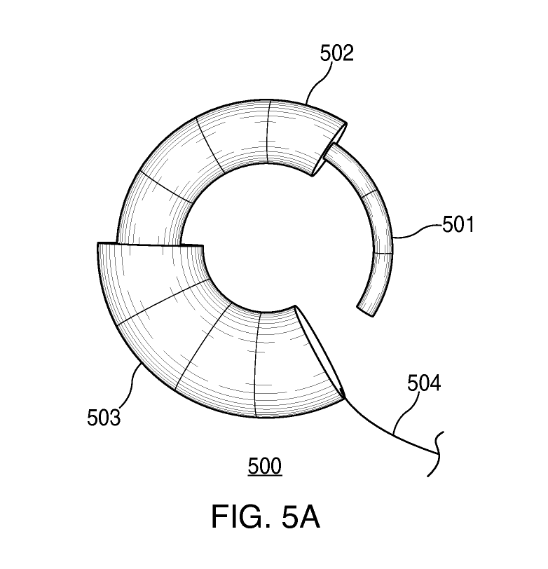

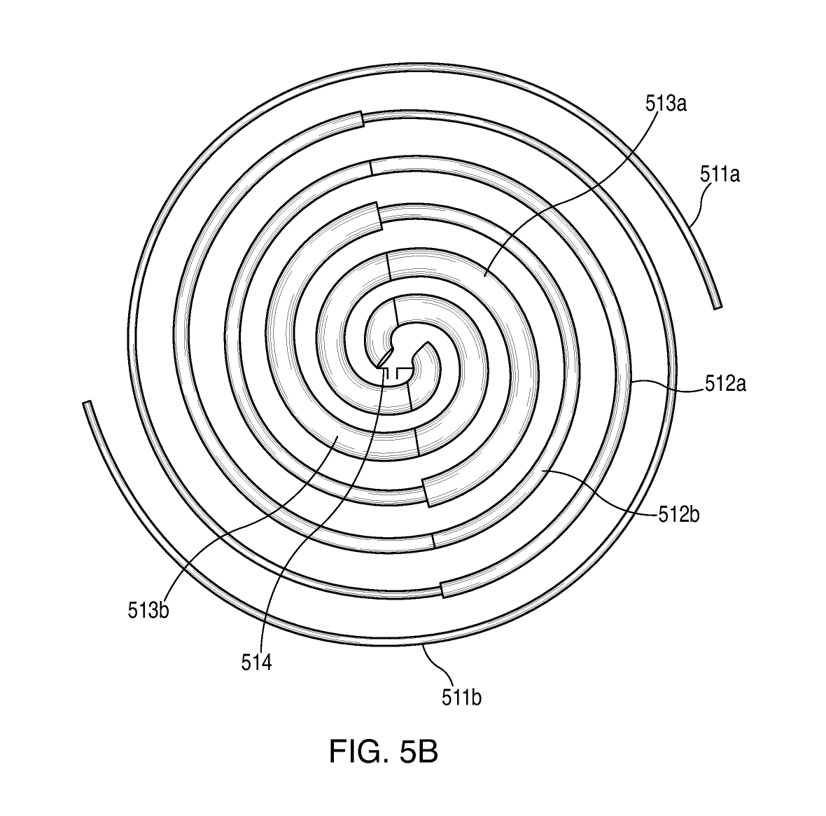

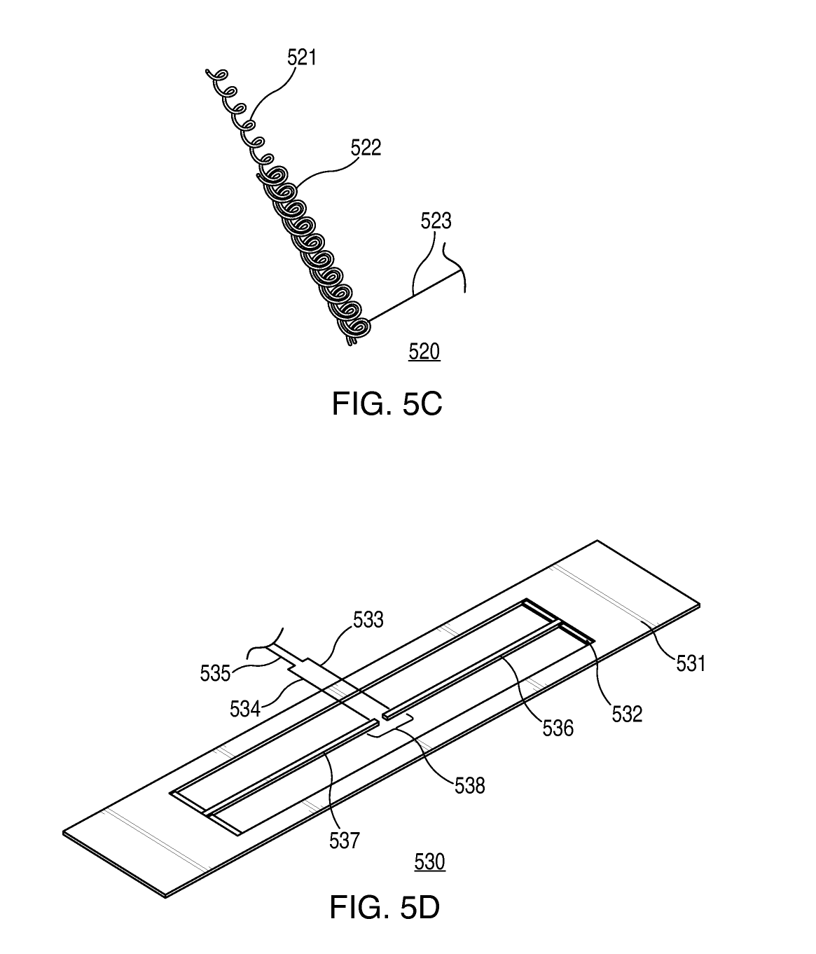

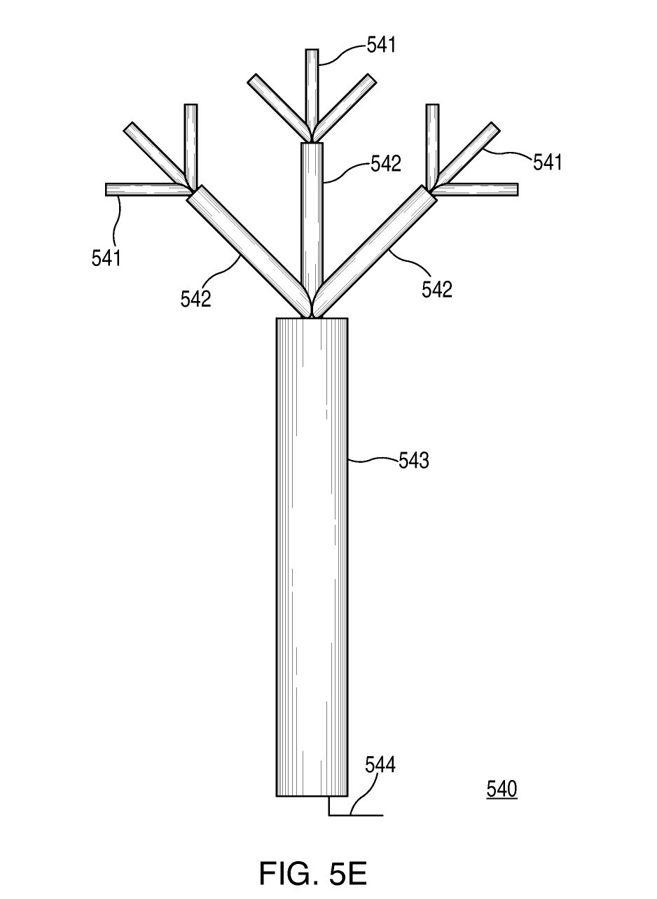

According to an illustrative embodiment, an antenna structure includes overlapping cylindrical tubes, with each tube separated by a dielectric and each tube a different length. Although cylindrical tubes are preferably used, other types of rods (solid or hollow, depending on the position) may be used, including but not limited to rods with square or oval cross-sections. The tube lengths are preferably arranged in descending order of length, such that the innermost tube is the longest and the outermost tube is the shortest. Each of the tubes is fed in phase simultaneously. A first end of each of the tubes is electrically connected with wires or a sector shaped disc and coupled to a feed line. As a results, each tube is impedance-matched to the source at its respective wavelength, while other tubes are poorly impedance-matched at that wavelength. The resonant tube radiation dominates the aggregate far field pattern, with a pattern shape identical to a standard dipole. As discussed with respect to FIGS. 5A to 5D below, this overlapping structure technique may be applied to a wide variety of antenna configurations beyond the three-band dipole configuration discussed with respect to FIGS. 1 to 4. As one of ordinary skill in the art will readily recognize, this overlapping structure may also be applied to a monopole structure, which is effectively one-half of the structure shown in FIGS. 1 and 2, with one conductor of the feed line coupled to the tubes forming the overlapping structure and the other conductor of the feed line coupled to ground.

Referring now to FIGS. 1 and 2, a multi-band dipole antenna 100 is shown consisting of a right hand portion (arm) 108 and a left hand portion (arm) 109 and having three separate frequency bands. The right arm 108 is spaced apart from and electrically isolated from the left arm 109, and the two arms 108, 109 are essentially mirror images of each other. As one of ordinary skill in the art will appreciate, conventional non-conducting structures are used to support arms 108, 109. Right arm 108 consists of an inner cylindrical tube (or solid rod) 101, a middle cylindrical tube 103 and an outer cylindrical tube 105. Middle tube 103 is hollow and positioned over inner tube 101, and outer tube 105 is hollow and positioned over middle tube 103. The left hand portion 109 consists of an inner cylindrical tube (or solid rod) 102, a middle cylindrical tube 104 and an outer cylindrical tube 106. Middle tube 104 is hollow and positioned over inner tube 102, and outer tube 106 is hollow and positioned over middle tube 104. A dielectric layer 201 (FIG. 2), preferably consisting of vacuum, separates tube 101 and tube 103. Likewise, a dielectric layer 202 (FIG. 2), also preferably consisting of vacuum, separates tube 103 and tube 105. As one of ordinary skill in the art will readily recognize, other types of dielectrics may be alternatively be employed. Although not shown in FIG. 2, dielectric layers are also positioned between tubes 102 and 104 and between tubes 104 and 106.

Each tube 101 to 106 has a fixed length and a fixed diameter, with tube pairs 101 and 102, 103 and 104, and 105 and 106 each having the same length and diameter. As discussed below, the tube lengths are pre-selected to set the three desired frequency bands.

Tubes 101, 103, 105 are positioned with their respective left ends aligned (as shown in FIG. 2). Similarly, tubes 102, 104, 106 are positioned with their respective right ends aligned. Tubes 101, 103, 105 are electrically connected, preferably by pie-slice shaped conductive elements 203, 204 (as shown in FIG. 2) which are coupled together and coupled to a wire 205 that is part of feed line 107. This ensures that the three tubes 101, 103, 105 are fed simultaneously in phase. Although not shown in FIG. 2, tubes 102, 104, 106 are similarly electrically connected to a wire 206 that is part of feed line 107 via pie-slice shaped conductive elements. As one of ordinary skill in the art will readily recognize, other types of connections, e.g., wire, may be alternatively employed to electrically couple the tubes in each arm 108, 109. The two individual arms 108 and 109 are separated from each other by a gap, preferably about 0.5″ and an ideal, balanced, voltage source with an output impedance of 73 ohms is preferably coupled to arms 108, 109 via a feed line 107 to form a compact multi-band antenna in a standard dipole configuration.

A dipole antenna is one of the most common forms of an antenna, and the most common form of a dipole antenna is a half-wave dipole. In such form, each of the arms has a length equal to one-quarter of the wavelength corresponding to the desired frequency of transmission (or reception). Applying this to the embodiment of FIGS. 1 and 2, the length of tubes 101, 102 sets the first frequency band, the length of tubes 103, 104 sets the second frequency band and the length of tubes 105, 106 sets the third frequency band. Table 1 below shows an example design for the three-band dipole antenna shown in FIGS. 1 and 2. As one of ordinary skill in the art will readily recognize, the principles of this embodiment may be applied to various different configurations, from a minimum of two tubes in each arm. In addition, although a dipole structure is shown, as discussed above one of ordinary skill in the art will readily recognize that the principles may also be applied to a monopole structure, i.e., a single arm with at least two overlapping tubes.

TABLE 1

| | Total Length | Resonant Frequency |
|---|---|---|
| Cylindrical Ring | (both arms) = λ/2 | (f = c/λ) |
| Inner | 36.5″ | 161.92 MHz |
| Middle | 24.5″ | 241.22 MHz |
| Outer | 12.5″ | 472.80 MHz |

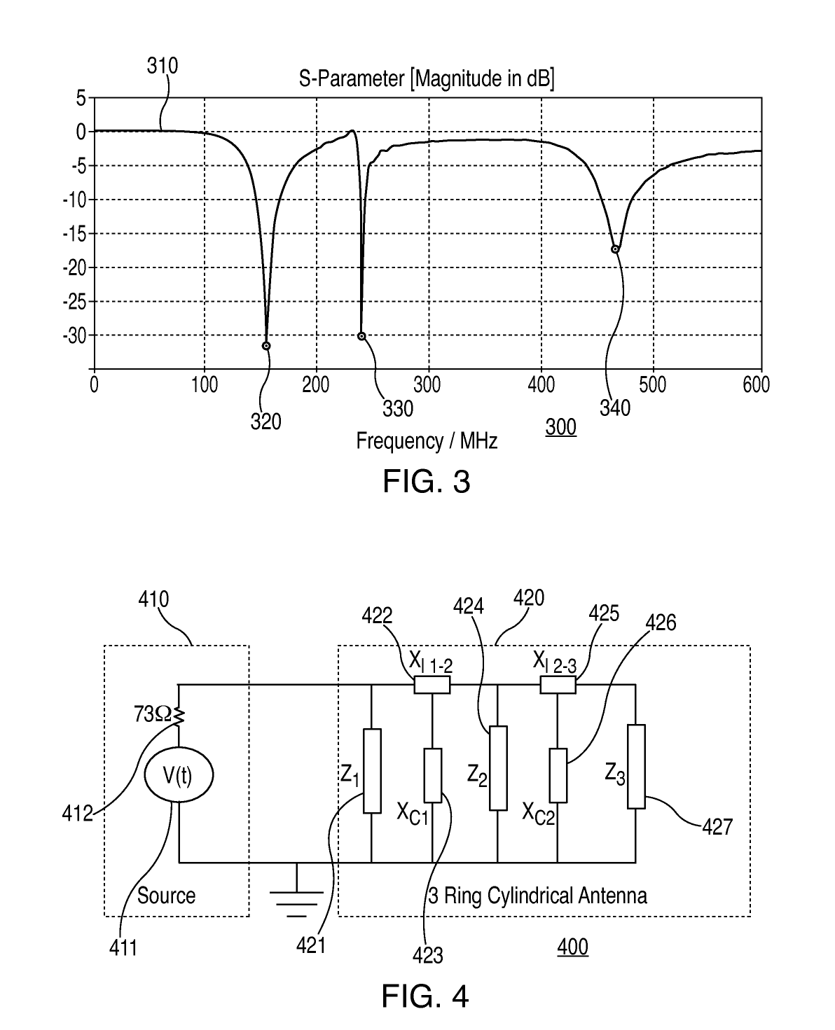

FIG. 3 shows a chart 300 taken from a reflection coefficient (S11) simulation output for the FIG. 1 antenna. Chart 300 has a characteristic 310 including resonant frequencies 320, 330 and 340. A comparison of the simulated resonant frequencies shown in FIG. 3 versus the frequencies calculated above in Table 1 is shown in Table 2. As evident, the simulation results show a slight deviation from the calculated results.

TABLE 2

| | Resonant Frequency | Simulated Resonant |
|---|---|---|
| Cylindrical Ring | (f = c/λ) | Frequency |
| Inner | 161.92 MHz | 157.2 MHz |
| Middle | 241.22 MHz | 241.8 MHz |
| Outer | 472.80 MHz | 467.0 MHz |

A standard half-wave dipole antenna constructed of infinitesimally thin cylindrical wires has a radiation resistance of 73 ohms (i.e., an input impedance of 73+j42.5 ohms) and a toroidal radiation pattern. The bandwidth of a standard half-wave dipole antenna varies according to its length and the diameter of its cylindrical arms. A ratio of length to diameter of 250 provides a 30% bandwidth, while a ratio of 5000 provides a 3% bandwidth. For example, a standard half-wave dipole antenna of 36.5″ length and 0.8″ diameter resonates at 144 MHz and an input impedance of approximately 70 ohms. At frequencies lower than 144 Mhz, the input impedance is lower than 70 ohms and at frequencies higher than 144 MHz (but lower than the second harmonic) the input impedance is higher than 70 ohms. Simulation shows that the input impedance for the dipole antenna shown in FIG. 1 decreases for each shorter ring, and the radiation pattern distorts for the outer most ring. Also, such simulation shows that the resonant frequency of each ring is not perfectly a function of its length, but the variations in resonant frequency (as shown in Table 2) are not severe.

An equivalent circuit 400 of the dipole antenna shown in FIG. 1 is depicted in FIG. 4. The source 410 includes an idea voltage source 411 (i.e., V(t)) and an ideal impedance 412 of 73 ohms. The antenna includes frequency dependent antenna input impedances Z₁ (421), Z₂ (424), and Z₃ (427). In addition, X_{C1} (423) and X_{C2} represent the shunt reactances formed by the tubes separated by a dielectric and are also frequency dependent. X_{L1-2} and X_{L2-3} represent the mutual inductances between the tubes. Thus, for a given set of tube lengths, the calculation of resonant frequency for each tube must take into account the mutual inductances, shunt capacitances and parallel impedances of the other tubes. Moreover, for the shorter tubes that form the outer rings, simulation shows that the currents coupled to the inner tubes may distort the resulting far field pattern when the wavelength of the outer ring is twice the wavelength of the innermost tube, so unless such distortion can be tolerated, the ration of smallest to largest frequencies should be limited to less than 2 to 1. Notably, as shown in Table 2, the calculation of the resonant frequencies based on each tube's length is fairly close to the actual (simulated) resonant frequency for each tube and can be used at least as an initial guide for the design for a particular application.

As discussed above, the structure disclosed herein may be used to create a multi-band monopole or bipole antenna that uses much less space than conventional antennas, with the amount of space saved proportional to the number of bands used for a particular antenna. FIGS. 5A to 5D show additional embodiments in different shapes.

Referring now to FIG. 5A, a multi-band circular antenna 500 is shown having an inner tube 501, a middle tube 502, and an outer tube 503. Tubes 501-503 are electrically coupled to one conductor of a feed line 504 at a common end (as with the monopole antenna, the second conductor of feed line 504 is coupled to ground). In addition, as with the embodiment of FIG. 1, a dielectric, preferably vacuum, is positioned between inner tube 501 and middle tube 502, and between middle tube 502 and outer tube 503.

Referring now to FIG. 5B, a two-part multi-band spiral antenna 510 is shown having inner tubes 511a, 511b, middle tubes 512a, 512b, and outer tubes 513a, 513b. Respective tubes 511a-513a are electrically coupled to a first conductor of a feed line 514 at a common end, respective tubes 511b-513b are electrically coupled to a second conductor of feed line 514 at common ends. In addition, as with the embodiment of FIG. 1, a dielectric, preferably vacuum, is positioned between associated inner tubes 511a, 511b and middle tubes 512a, 512b, and between middle tubes 512a, 512b and outer tubes 513a, 513b.

Referring now to FIG. 5C, a multi-band helical antenna 520 is shown having an inner helix 521 and an outer helix 522. Helixes 521, 522 are electrically coupled to one conductor of a feed line 523 at a common end (as with the monopole antenna, the second conductor of feed line 523 is coupled to ground). In addition, as with the embodiment of FIG. 1, a dielectric, preferably vacuum, is positioned between inner helix 521 and middle helix 522.

Referring now to FIG. 5D, a slot antenna 530 is shown having an upper slot antenna 531 positioned over a lower slot antenna 532. Upper slot antenna 531 is separated from lower slot antenna 532 by a dielectric, preferably vacuum, and each antenna 531, 532 is electrically coupled only at the center portion 538. In particular, tine 536 of upper slot antenna 531 is electrically coupled to a first tine of the lower slot antenna (not shown) and to conductor 533 of feed line 535 and tine 537 of the upper slot antenna 531 is electrically coupled to a second tine of the lower slot antenna (not shown) and to conductor 535 of feed line 535.

Referring now to FIG. 5E, a fractal-shaped antenna 540 is shown having an inner tube 541, a middle tube 542, and an outer tube 543. Tubes 541-543 are electrically coupled to one conductor of a feed line 544 at a common end (as with the monopole antenna, the second conductor of feed line 544 is coupled to ground). In addition, as with the embodiment of FIG. 1, a dielectric, preferably vacuum, is positioned between inner tube 541 and middle tube 542, and between middle tube 542 and outer tube 543.

Although the present invention has been particularly shown and described with reference to the preferred embodiments and various aspects thereof, it will be appreciated by those of ordinary skill in the art that various changes and modifications may be made without departing from the spirit and scope of the invention. It is intended that the appended claims be interpreted as including the embodiments described herein, the alternatives mentioned above, and all equivalents thereto.

What is claimed is:

1. A multi-band antenna, comprising:
a first conductive element having a central axis, a predetermined cross-sectional shape, and a predetermined first length;
a second conductive element having a central axis, a predetermined cross-sectional shape and a predetermined second length, the second conductive element being hollow, the predetermined cross-sectional shape of the second conductive element sized to allow the second conductive element to fit over the first conductive element without contact between the first conductive element and the second conductive element, the second conductive element aligned over the first conductive element such that the central axis of the first conductive element coincides with the central axis of the second conductive element and such that a first end of the first conductive element is in the same plane as a first end of the second conductive element; and
a first conductive member coupled to the first end of the first conductive element and to the first end of the second conductive element.

2. The multi-band antenna of claim 1, wherein a spacing between the first conductive element and the second conductive element acts as a dielectric.

3. The multi-band antenna of claim 1, further comprising a dielectric between the first conductive element and the second conductive element.

4. The multi-band antenna of claim 1, wherein the predetermined cross-sectional shape of the first conductive element of the first conductive element is the same as the predetermined cross-sectional shape of the second conductive element.

5. The multi-band antenna of claim 4, wherein the predetermined cross-sectional shape is a circle.

6. The multi-band antenna of claim 4, wherein the predetermined cross-sectional shape is one of square, oval and triangular.

7. The multi-band antenna of claim 1, wherein the first conductive element and the second conductive element form straight rods.

8. The multi-band antenna of claim 1, wherein the first conductive element and the second conductive element form looped rods.

9. The multi-band antenna of claim 1, wherein the first conductive element and the second conductive element form spiral rods.

10. The multi-band antenna of claim 1, wherein the first conductive element and the second conductive element form a fractal shape.

11. The multi-band antenna of claim 1, further comprising a feed line coupled to the first conductive member such that the conductive elements coupled to the first conductive member are fed in phase.

12. The multi-band antenna of claim 1, further comprising:
a third conductive element having a central axis, a predetermined cross-sectional shape and a predetermined third length, the third conductive element being hollow, the predetermined cross-sectional shape of the third conductive element sized to allow the third conductive element to fit over the second conductive element without contact between the second conductive element and the third conductive element, the third conductive element aligned over the second conductive element such that the central axis of the second conductive element coincides with the central axis of the third conductive element and such that a first end of the second conductive element is in the same plane as a first end of the third conductive element; and
wherein the first conductive member is also coupled to the first end of the third conductive element.

13. The multi-band antenna of claim 1, further comprising:
a third conductive element having a central axis, a predetermined cross-sectional shape the same as the predetermined cross-sectional shape of the first conductive element, and a predetermined third length, the third conductive element aligned adjacent to the first conductive element so that the central axis of the first conductive element is in line with the central axis of the third conductive element and so that the first end of the first conductive element is adjacent to but spaced apart from a first end of the third conductive element;
a fourth conductive element having a central axis, a predetermined cross-sectional shape the same as the predetermined cross-sectional shape of the second conductive element and a predetermined fourth length, the fourth conductive element being hollow, the predetermined cross-sectional shape of the fourth conductive element sized to allow the fourth conductive element to fit over the third conductive element without contact between the third conductive element and the fourth conductive element, the fourth conductive element aligned over the third conductive element such that the central axis of the third conductive element coincides with the central axis of the fourth conductive element and such that the first end of the third conductive element is in the same plane as a first end of the fourth conductive element; and
a second conductive member coupled to the first end of the third conductive element and to the first end of the fourth conductive element.

14. The multi-band antenna of claim 13, further comprising a feed line having a first conductor coupled to the first conductive member and a second conductor coupled to the second conductive member such that the conductive elements coupled to each conductive member are fed in phase.

15. The multi-band antenna of claim 13, wherein the predetermined second length is less than the predetermined first length and the predetermined fourth length is less than the predetermined third length.

16. The multi-band antenna of claim 12, further comprising:
a fourth conductive element having a central axis, a predetermined cross-sectional shape the same as the predetermined cross-sectional shape of the first conductive element, and a predetermined fourth length, the fourth conductive element aligned adjacent to the first conductive element so that the central axis of the first conductive element is in line with the central axis of the fourth conductive element and so that the first end of the first conductive element is adjacent to but spaced apart from a first end of the fourth conductive element;
a fifth conductive element having a central axis, a predetermined cross-sectional shape the same as the predetermined cross-sectional shape of the second conductive element and a predetermined fifth length, the fifth conductive element being hollow, the predetermined cross-sectional shape of the fifth conductive element sized to allow the fifth conductive element to fit over the fourth conductive element without contact between the fourth conductive element and the fifth conductive element, the fifth conductive element aligned over the fourth conductive element such that the central axis of the fourth conductive element coincides with the central axis of the fifth conductive element and such that the first end of the fourth conductive element is in the same plane as a first end of the fifth conductive element;
a sixth conductive element having a central axis, a predetermined cross-sectional shape and a predetermined sixth length, the sixth conductive element being hollow, the predetermined cross-sectional shape of the sixth conductive element sized to allow the sixth conductive element to fit over the fifth conductive element without contact between the fifth conductive element and the sixth conductive element, the sixth conductive element aligned over the fifth conductive element such that the central axis of the fifth conductive element coincides with the central axis of the sixth conductive element and such that a first end of the fifth conductive element is in the same plane as a first end of the sixth conductive element; and
a second conductive member coupled to the first end of the fourth conductive element, to the first end of the fifth conductive element, and to the first end of the sixth conductive element.

17. The multi-band antenna of claim 15, further comprising a feed line having a first conductor coupled to the first conductive member and a second conductor coupled to the second conductive member such that the conductive elements coupled to each conductive member are fed in phase.

18. The multi-band antenna of claim 15, wherein the predetermined second length is less than the predetermined first length, the predetermined third length is less than the predetermined second length, the predetermined fifth length is less than the predetermined fourth length, and the predetermined sixth length is less than the predetermined fifth length.

19. A multi-band antenna, comprising:
a first helical element having a central axis, a predetermined cross-sectional outer diameter, and a predetermined first length;
a second helical element having a central axis, a predetermined cross-sectional inner diameter and a predetermined second length, the predetermined cross-sectional inner diameter of the second helical element greater than the predetermined cross-sectional outer diameter of the first helical element so that the second helical element fits over the first helical element without contact between the first helical element and the second helical element, the second helical element aligned over the first helical element such that the central axis of the first helical element coincides with the central axis of the second helical element and such that a first end of the first helical element is in the same plane as a first end of the second helical element;
a first conductive member coupled to the first end of the first helical element and to the first end of the second helical element; and
a feed line having a first conductor coupled to the first conductive member such that the first and second helical elements coupled to the first conductive member are fed in phase.

20. A multi-band antenna, comprising:
a first slot antenna formed from a first metal plate, the first metal plate having an aperture formed therein, the aperture having a predetermined first size corresponding to a particular first resonant frequency, the first slot antenna having a first tine and a second tine, the first tine having a first end and a second end, the first end of the first tine electrically coupled to the second metal plate at a first side of the aperture and the second end of the first tine positioned in a middle portion of the aperture, the second tine having a first end and a second end, the first end of the second tine electrically coupled to the second metal plate at a second side of the aperture opposite the first side and the second end of the second tine positioned in the middle portion of the aperture, the second end of the first tine separate from and not electrically coupled to the second end of the second tine;
a second slot antenna formed from a second metal plate, the second metal plate having an aperture formed therein, the aperture having a predetermined second size corresponding to a particular second resonant frequency, the second slot antenna having a first tine and a second tine, the first tine having a first end and a second end, the first end of the first tine electrically coupled to the second metal plate at a first side of the aperture and the second end of the first tine positioned in a middle portion of the aperture, the second tine having a first end and a second end, the first end of the second tine electrically coupled to the second metal plate at a second side of the aperture opposite the first side and the second end of the second tine positioned in the middle portion of the aperture, the second end of the first tine separate from and not electrically coupled to the second end of the second tine, wherein the first slot antenna is positioned over but spaced apart from the second slot antenna such that the second end of the first tine of the first slot antenna is adjacent to the second end of the first tine of the second slot antenna and the second end of the second tine of the first slot antenna is adjacent to the second end of the second tine of the second slot antenna;
a first conductive member coupled to the second end of the first tine of the first slot antenna and to the second end of the first tine of the second slot antenna;
a second conductive member coupled to the second end of the second tine of the first slot antenna and to the second tine of the second slot antenna; and
a feed line coupled to the first and second conductive members such that the first and second slot elements are coupled to the feed line through the conductive members.
